(19) United States
(12) Patent Application Publication
(10) Pub. No.: US 2024/0146782 A1
(43) Pub. Date: May 2, 2024

(54) SERVICE SWITCHING METHOD, ELECTRONIC DEVICE, AND STORAGE MEDIUM

(71) Applicant: BEIJING DAJIA INTERNET INFORMATION TECHNOLOGY CO., LTD., Beijing (CN)

(72) Inventor: Yuzhang YUAN, Beijing (CN)

(21) Appl. No.: 18/473,686

(22) Filed: Sep. 25, 2023

(30) Foreign Application Priority Data
Oct. 31, 2022 (CN) 202211349461.0

(51) Int. Cl. H04L 65/401; H04L 65/1069

(52) U.S. Cl. CPC H04L 65/4015; H04L 65/1069

(57) ABSTRACT

A service switching method includes: acquiring service switching information by switching, in response to a service switching instruction for a target virtual space, an interactive service ongoing in the target virtual space from a current interactive service to a target interactive service indicated by the service switching instruction; and transmitting the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

The present disclosure is based upon and claims priority to Chinese Patent Application No. 202211349461.0, filed on Oct. 31, 2022, and entitled “METHOD AND APPARATUS FOR SWITCHING SERVICE, ELECTRONIC DEVICE, AND STORAGE MEDIUM,” the content of which is herein incorporated by reference in its entirety.

### TECHNICAL FIELD

The present disclosure relates to the technical field of the Internet, and in particular, relates to a service switching method, an electronic device, and a storage medium.

### BACKGROUND

With the development of the internet and live streaming technology, there are increasingly more interactive services during the live streaming process, such as battles, co-hosting, connection, and chat rooms. In the related art, servers corresponding to different types of services are independent of each other. For example, during the process of switching services from one to another, an anchor needs to first manually disable a current interactive service, then re-establish connections to other users who have interacted with the anchor previously. In the above process, the operation path is long and cumbersome, which leads to problems such as low efficiency of switching and poor user experiences.

### SUMMARY

Various embodiments of the present disclosure provide a service switching method, an electronic device, and a storage medium.

According to one aspect of the embodiments of the present disclosure, a service switching method is provided. The method is applicable to an electronic device, and the method includes:

acquiring service switching information by switching, in response to a service switching instruction for a target virtual space, an interactive service ongoing in the target virtual space from a current interactive service to a target interactive service indicated by the service switching instruction; and

transmitting the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

In some embodiments, acquiring the service switching information by switching the interactive service ongoing in the target virtual space from the current interactive service to the target interactive service indicated by the service switching instruction includes:

acquiring the service switching information by switching the interactive service from the current interactive service to the target interactive service by calling a service switching function.

In some embodiments, the service switching function includes: a service disablement function, a service enablement function, and a service rendering function; and

acquiring the service switching information by switching the interactive service from the current interactive service to the target interactive service by calling the service switching function includes:

acquiring service disablement information by disabling the current interactive service by calling the service disablement function;

acquiring service enablement information corresponding to the target interactive service by enabling the target interactive service by calling the service enablement function;

acquiring target service rendering information corresponding to the target interactive service by calling the service rendering function; and

generating the service switching information based on the target service rendering information, the service disablement information, and the service enablement information.

In some embodiments, the service switching function further includes a first check function and a second check function; and the method further includes:

acquiring a service disablement check result by performing a service disablement check on the current interactive service by calling the first check function; and

acquiring a service enablement check result by performing a service enablement check on the target interactive service by calling, in response to the service disablement check result indicating a successful check, the second check function; and

acquiring the service disablement information by disabling the current interactive service by calling the service disablement function includes:

in response to the service enablement check result indicating a successful check, performing the step of acquiring the service disablement information by disabling the current interactive service by calling the service disablement function.

In some embodiments, acquiring the service disablement check result by performing the service disablement check on the current interactive service by calling the first check function includes:

acquiring a first check result corresponding to the first check function by calling the first check function; and determining the first check result as the service disablement check result; or

transmitting a service disablement check instruction to a first service server corresponding to the current interactive service by calling the first check function, wherein the service disablement check instruction is to instruct the first service server to perform the service disablement check on the current interactive service; and acquiring a first callback check result corresponding to the first check function, wherein the first callback check result is the service disablement check result corresponding to the current interactive service, which is returned by the first service server.

In some embodiments, acquiring the service enablement check result by performing the service enablement check on the target interactive service by calling the second check function includes:

acquiring a second check result corresponding to the second check function by calling the second check function; and determining the second check result as the service enablement check result; or

transmitting a service enablement check instruction to a second service server corresponding to the target interactive service by calling the second check function, wherein the service enablement check instruction is to instruct the second service server to perform the service enablement check on the target interactive service; and acquiring a second callback check result corresponding to the second check function, wherein the second callback check result is the service enablement check result corresponding to the target interactive service, which is returned by the second service server.

In some embodiments, acquiring the service disablement information by disabling the current interactive service by calling the service disablement function includes:

generating the service disablement information by locally disabling the current interactive service by calling the service disablement function; or

transmitting a service disablement instruction to a first service server corresponding to the current interactive service by calling the service disablement function, wherein the service disablement instruction is to instruct the first service server to disable the current interactive service; and acquiring a first callback result corresponding to the service disablement function, wherein the first callback result is the service disablement information generated by the first service server in response to disabling the current interactive service.

In some embodiments, acquiring the service enablement information corresponding to the target interactive service by enabling the target interactive service by calling the service enablement function includes:

generating the service enablement information by locally enabling the target interactive service by calling the service enablement function; or

transmitting a service enablement instruction to a second server corresponding to the target interactive service by calling the service enablement function, wherein the service enablement instruction is to instruct the second server to enable the target interactive service in the target virtual space; and acquiring a second callback result corresponding to the service enablement function, wherein the second callback result is the service enablement information generated by the second server in response to enabling the target interactive service in the target virtual space.

In some embodiments, acquiring the target service rendering information corresponding to the target interactive service by calling the service rendering function includes:

acquiring service rendering information corresponding to the service rendering function by calling the service rendering function; and determining the service rendering information as the target service rendering information; or

transmitting a service information configuration instruction to a second service server corresponding to the target interactive service by calling the service rendering function, wherein the service information configuration instruction is to instruct the second service server to configure the target service rendering information; and acquiring a third callback result corresponding to the service enablement function, wherein the third callback result is the target service rendering information returned by the second service server.

In some embodiments, the method further includes:

setting the target virtual space to be in a locked state in response to the service switching instruction, wherein in the target virtual space in the locked state, joining and exiting of an object are suspended, and triggering of the service switching is suspended.

In some embodiments, the method further includes:

unlocking the target virtual space.

In some embodiments, the method further includes:

in response to a failure to perform a service switching operation, disabling the target virtual space and transmitting service disablement information to the object; wherein the service disablement information indicates that the target virtual space is disabled in response to the failure to perform the service switching operation, and the target virtual space is a live-streaming room for performing the current interactive service.

In some embodiments, the service switching instruction is triggered by a target object in the objects; and transmitting the service switching information to the object in the target virtual space includes:

transmitting the service switching information to the target object by calling a preset application interface; and

forwarding the service switching information to other objects according to a preset signaling service;

wherein the other objects are objects other than the target object in the objects.

In some embodiments, the method further includes:

acquiring service state information corresponding to a current service participant object in the objects, wherein the service state information characterizes a state of the current service participant object involved in the current interactive service in the target virtual space; and

clearing, based on the service state information, objects in the target virtual space that do not satisfy a service switching condition; and

transmitting the service switching information to the object in the target virtual space includes:

transmitting the service switching information to a target service participant object, wherein the target service participant object is an object in the current service participant object, whose service state information satisfies the service switching condition.

In some embodiments, the method further includes:

acquiring service type information corresponding to the target interactive service and service identification information of the target interactive service in the target virtual space; and

updating, based on the service type information and the service identification information, service indication information corresponding to the target virtual space, wherein the service indication information indicates an interactive service currently running in the target virtual space.

According to another aspect of the embodiments of the present disclosure, an electronic device is provided. The electronic device includes a processor, and a memory configured to store one or more instructions executable by the processor. The processor, when loading and executing the one or more instructions, is caused to:

acquire service switching information by switching, in response to a service switching instruction for a target virtual space, an interactive service ongoing in the target virtual space from a current interactive service to a target interactive service indicated by the service switching instruction; and

transmit the service switching information to an object in the target virtual space, wherein the service switching information is to instruct the interactive service ongoing in the target virtual space to be switched from the current interactive service to the target interactive service, and to switch a page content in a space page of the target virtual space to a page content corresponding to the target interactive service.

According to still another aspect of the embodiments of the present disclosure, a computer-readable storage medium storing one or more instructions therein is provided. The one or more instructions, when loaded and executed by a processor of an electronic device, cause the electronic device to:
acquire service switching information by switching, in response to a service switching instruction for a target virtual space, an interactive service ongoing in the target virtual space from a current interactive service to a target interactive service indicated by the service switching instruction; and

transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

According to still another aspect of the embodiments of the present disclosure, a computer program product storing one or more instructions therein is provided. The one or more instructions, when loaded and executed on a computer, cause the computer to:

acquire service switching information by switching, in response to a service switching instruction for a target virtual space, an interactive service ongoing in the target virtual space from a current interactive service to a target interactive service indicated by the service switching instruction; and

transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

It should be understood that the general description above and the detailed description hereinafter are exemplary and explanatory only and do not limit the present disclosure.

### BRIEF DESCRIPTION OF DRAWINGS

The accompanying drawings herein, which are incorporated into and form a part of the specification, illustrate embodiments consistent with the present disclosure and are used in conjunction with the specification to explain the principles of the present disclosure, which do not constitute any undue limitation to the present disclosure.

FIG. 1 is a schematic diagram of an application environment according to some embodiments of the present disclosure;

FIG. 2 is a flowchart of a service switching method according to some embodiments of the present disclosure;

FIG. 3 is a flowchart of generating service switching information according to some embodiments of the present disclosure;

FIG. 4 is a schematic diagram of a service switching process according to some embodiments of the present disclosure;

FIG. 5 is a block diagram of a service switching apparatus according to some embodiments of the present disclosure; and

FIG. 6 is a block diagram of an electronic device for service switching according to some embodiments of the present disclosure.

### DETAILED DESCRIPTION

The present disclosure is described in further detail with reference to the accompanying drawings, to clearly present the objects, technical solutions, and advantages of the present disclosure.

It should be noted that the terms “first,” “second,” and the like in the specification, claims of the present disclosure, and the accompanying drawings described above are used to distinguish similar objects and are not intended to describe any particular order or sequence. It should be understood that the data limited by such terms may be interchanged in appropriate cases, such that the embodiments of the present disclosure described herein can be implemented in an order other than those illustrated or described herein. The embodiments described in the following exemplary embodiments do not represent all embodiments consistent with the present disclosure. Rather, they are only examples of apparatus and methods consistent with some aspects of the present disclosure as detailed in the appended claims.

It should be noted that the user information (including, but not limited to, user device information and user personal information) and data (including, but not limited to, data for display and data for analysis) involved in the present disclosure are information and data that have been authorized by the user or have been fully authorized by the parties.

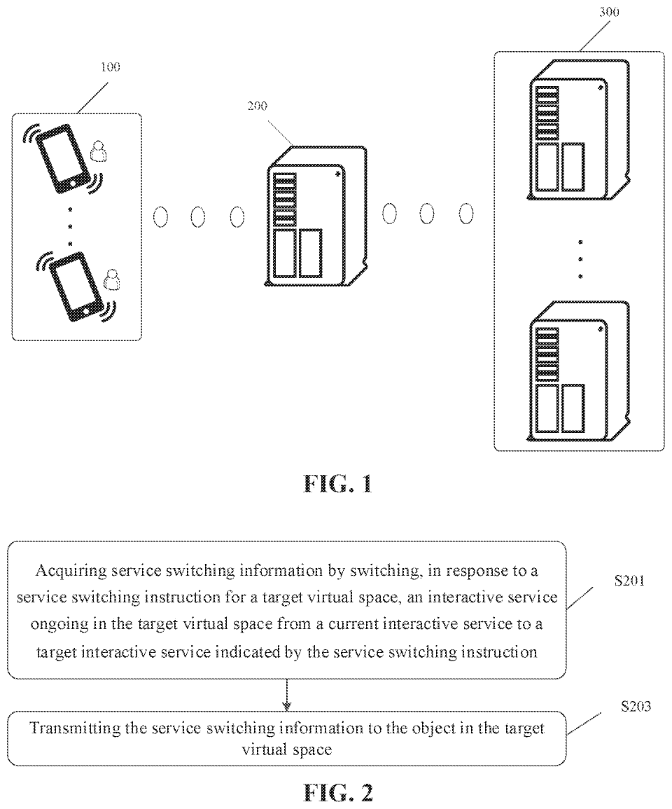

FIG. 1 is a schematic diagram of an application environment according to some embodiments of the present disclosure. Referring to FIG. 1, the application environment includes at least two terminals 100, a server 200, and at least two service servers 300.

In some embodiments, the at least two terminals 100 correspond to user accounts involved in an interactive service in the same target virtual space. The server 200 provides background services, such as service switching services, for the live streaming process of the at least two terminals 100. The at least two service servers 300 correspond to the at least two interactive services.

In some embodiments, the terminal 100 includes, but is not limited to, an electronic device such as a smartphone, a desktop computer, a tablet, a laptop, a smart speaker, a digital assistant, an augmented reality (AR)/virtual reality (VR) device, or a smart wearable, or a software, such as an application, running on the electronic device. Operating systems running on the electronic device include, but are not limited to, Android, iOS, Linux, and Windows.

In some embodiments, the server is an independent physical server, a server cluster or distributed system consisting of a plurality of physical servers, or a cloud server providing cloud computing services.

In addition, it should be noted that what is illustrated in FIG. 1 is only one application environment according to the present disclosure, and in practice, other application environments are included. For example, the target virtual space includes terminals corresponding to more user accounts involved in the interactive service.

The at least two terminals 100, the server 200, and the at least two service servers 300 described above are connected directly or indirectly by wired or wireless communication, which is not limited herein.

FIG. 2 is a flowchart of a service switching method according to some embodiments of the present disclosure. The method is applicable to an electronic device, such as the server 200 in FIG. 1. The electronic device is configured to perform service switching services, and communicate with at least two interactive service servers. For example, the electronic device may be the server 200 illustrated in FIG. 1. As illustrated in FIG. 2, the method includes the steps described below.

In S201, service switching information is acquired by switching, in response to a service switching instruction for a target virtual space, an interactive service ongoing in the target virtual space from a current interactive service to a target interactive service indicated by the service switching instruction.

In some embodiments, the service switching information is acquired by switching the interactive service from the current interactive service to the target interactive service by calling a service switching function. The service switching function is preset in the electronic device.

In some embodiments, the target virtual space is a live-streaming room for performing the current interactive service, and at least two objects in the target virtual space are involved in the current interactive service. The object herein is a user account. The interactive service that is available for users in the target virtual space is configured according to the actual application, and the interactive service includes a connection service, a co-hosting service, a battle service, a chat service, and the like. The electronic device may be configured to perform service switching services among the interactive services. In some embodiment, the electronic device is configured to have a service switching function, which may include service disablement function, service enablement function, and service rendering function.

In some embodiments, the service switching instruction to switch the interactive service from the current interactive service to the target interactive service is triggered in the target virtual space according to the actual application requirement. Assuming that the current interactive service in the target virtual space is a connection service and the target interactive service is a battle service, then the service switching instruction is a service switching instruction to switch the interactive service from the connection service to the battle service. Assuming that the current interactive service in the target virtual space is a battle service and the target interactive service is also a battle service, then the service switching instruction is a service switching instruction to switch the interactive service from one battle service to another battle service (i.e., re-enabling a battle service in the target virtual space).

In some embodiments, the service switching instruction is triggered by any object in the target virtual space that is involved in the current interactive service. For example, an object involved in the current interactive service (a current service participant object) triggers the service switching instruction by clicking on a trigger control corresponding to the target interactive service on a page of the target virtual space. Alternatively, the service switching instruction is automatically triggered in response to satisfying a preset trigger condition. For example, a current service participant object a, a current service participant object b, and a current service participant object c are involved in a battle service in the target virtual space, and the service switching instruction to switch the battle service to a connection service is automatically triggered in response to an end of a countdown of a vote corresponding to the battle service.

In some embodiments, the service switching function is configured to perform the service switching operation.

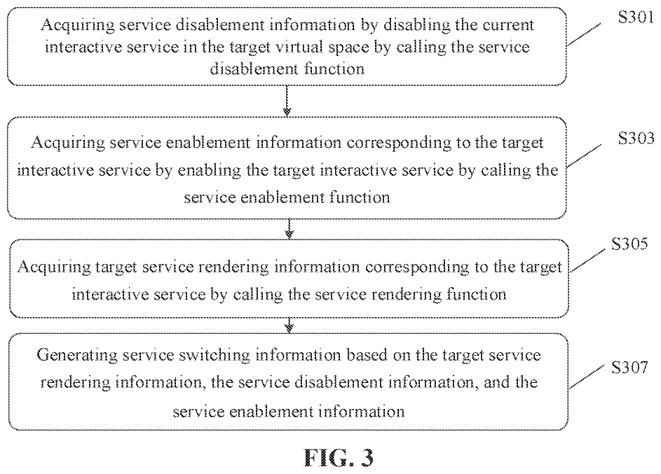

In some embodiments, the service switching function includes a service disablement function, a service enablement function, and a service rendering function. Accordingly, as illustrated in FIG. 3, acquiring the service switching information by switching the interactive service from the current interactive service to the target interactive service by calling the service switching function includes the following steps.

In S301, service disablement information is acquired by disabling the current interactive service in the target virtual space by calling the service disablement function.

In S303, service enablement information corresponding to the target interactive service is acquired by enabling the target interactive service by calling the service enablement function.

In S305, target service rendering information corresponding to the target interactive service is acquired by calling the service rendering function.

In S307, service switching information is generated based on the target service rendering information, the service disablement information, and the service enablement information.

In some embodiments, acquiring the service disablement information by disabling the current interactive service in the target virtual space by calling the service disablement function includes:

generating the service disablement information by locally disabling the current interactive service in the target virtual space by calling the service disablement function; or

transmitting a service disablement instruction to a first service server corresponding to the current interactive service by calling the service disablement function; and acquiring a first callback result corresponding to the service disablement function, wherein the first callback result is the service disablement information generated by the first service server in response to disabling the current interactive service. The first service server may be one of the service servers 300 as illustrated in FIG. 1.

In some embodiments, the service disablement function is configured to perform the service disablement. In the case that the first service server pre-performs a registration configuration for the service disablement, accordingly, in a scenario where the current interactive service is switched to the target interactive service (interactive services other than the current interactive service), where the service disablement function is called, the service disablement function triggers an access operation to the first service server, transmits the service disablement instruction to the first service server, and thereby instructs the first service server to perform the service disablement. Accordingly, the service disablement instruction is to instruct the first service server to disable the current interactive service in the target virtual space. The first service server generates the service disablement information in response to disabling the current interactive service in the target virtual space. The service disablement information indicates that the current interactive service is disabled. The first service server returns the service disablement information to the service disablement function in a form of a callback result (the first callback result) corresponding to the service disablement function.

In some embodiments, in the case that the first service server does not perform the registration configuration for the service disablement, accordingly, in a scenario where the current interactive service is switched to the target interactive service, where the service disablement function is called, the current interactive service is locally disabled in the target virtual space, and the service disablement information is generated.

In the above embodiments, in response to triggering the service switching instruction for the target virtual space, by calling the service disablement function, the operation of disabling the current interactive service by the first service server is automatically triggered, or the current interactive service is locally disabled, which greatly improves the flexibility in disabling the current interactive service in the process of service switching. In the case that the current interactive service is locally disabled, there is no need to access the first service server, which improves the efficiency of service disablement is improved, and thus further improve the efficiency of service switching.

In some embodiments, acquiring the service enablement information corresponding to the target interactive service by enabling the target interactive service by calling the service enablement function includes:

generating the service enablement information by locally enabling the target interactive service in the target virtual space by calling the service enablement function; or

transmitting a service enablement instruction to a second service server corresponding to the target interactive service by calling the service enablement function, wherein the service enablement instruction is to instruct the second service server to enable the target interactive service in the target virtual space; and acquiring a second callback result corresponding to the service enablement function, wherein the second callback result is the service enablement information generated by the second service server in response to enabling the target interactive service in the target virtual space. The second service server may be one of the service servers 300 as illustrated in FIG. 1.

In some embodiments, the service enablement function is configured to perform the service enablement. In the case that the second service server pre-performs a registration configuration for the service enablement, accordingly, in a scenario where the current interactive service is switched to the target interactive service, where the service enablement function is called, the service enablement function triggers an access operation to the second service server, transmits the service enablement instruction to the second service server, and thereby instructs the second service server to perform the service enablement. Accordingly, the service enablement instruction is to instruct the second service server to enable the target interactive service in the target virtual space. The second service server generates the service enablement information in response to enabling the target interactive service in the target virtual space. The service enablement information indicates that the target interactive service is enabled. The second service server returns the service enablement information to the service enablement function in a form of a callback result (the second callback result) corresponding to the service enablement function.

In some embodiments, in the case that the second service server does not perform the registration configuration for the service enablement, accordingly, in a scenario where the current interactive service is switched to the target interactive service, where the service enablement function is called, the target interactive service is locally enabled in the target virtual space, and the service enablement information is generated.

In the above embodiments, by calling the service enablement function, the operation of enabling the target interactive service in the target virtual space by the second service server is automatically triggered, or the target interactive service is locally enabled in the target virtual space, which greatly improves the flexibility in enabling the target interactive service in the process of service switching. In the case the target interactive service is locally enabled, there is no need to access the second service server, which improves the efficiency of service, and thus further improves the efficiency of service switching.

In some embodiments, acquiring the target service rendering information corresponding to the target interactive service by calling the service rendering function includes:

acquiring service rendering information corresponding to the service rendering function by calling the service rendering function; and determining the service rendering information as the target service rendering information; or

transmitting a service information configuration instruction to the second service server by calling the service rendering function; acquiring a third callback result corresponding to the service enablement function, wherein the third callback result is the target service rendering information returned by the second service server.

In some embodiments, the service rendering function is configured to perform a configuration for the service rendering information. In the case that the second service server pre-performs a registration configuration for the service rendering information, accordingly, in a scenario where the current interactive service is switched to the target interactive service, where the service rendering function is called, the service rendering function triggers an access operation to the second service server, transmits the service information configuration instruction to the second service server, and thereby instructs the second service server to perform the configuration for the service rendering information. Accordingly, the service information configuration instruction is to instruct the second service server to configure the target service rendering information; and the second service server, with the target service rendering information configured, returns the target service rendering information to the service rendering function in a form of a callback result (the third callback result) corresponding to the service rendering function.

In some embodiments, some interactive services often use service rendering information set by default. That is, there is no need to perform the registration configuration for the service rendering information. Accordingly, in the case that the second service server does not perform the registration configuration for the service rendering information, in a scenario where the current interactive service is switched to the target interactive service, where the service rendering function is called, the service rendering information corresponding to the service rendering function is determined as the target service rendering information. The target service rendering information is configured to render a content of a page corresponding to the target interactive service.

In the above embodiments, by calling the service rendering function, the configuration for the target service rendering information by the second service server is automatically triggered, or the service rendering information is determined as the target service rendering information, which greatly improves the flexibility in configuring the service rendering information corresponding to the target interactive service in the process of service switching. In the case that the service rendering information is served as the target service rendering information, there is no need to access the second service server, such that the efficiency of the configuration for the service rendering information is improved, and thus the efficiency of service switching is improved.

In some embodiments, the service switching information is acquired by packaging the service disablement information, the service enablement information, and the target service rendering information into a signaling.

In the above embodiments, by setting the service disablement function, the service enablement function, and the service rendering function, during the service switching process, the current interactive service is locally disabled, the target interactive service that needs to be switched is locally enabled, and the target service rendering information is acquired, such that the service switching information required for switching the current interactive service to the target interactive service is generated. In this way, the service is switched in the target virtual space with one button, which greatly improves the efficiency of service switching.

In some embodiments, the service switching function further includes a first check function and a second check function. Accordingly, upon acquiring the service disablement information by disabling the current interactive service by calling the service disablement function, the method further includes:

acquiring a service disablement check result by performing a service disablement check on the current interactive service by calling the first check function; and

acquiring a service enablement check result by performing a service enablement check on the target interactive service by calling, in response to the service disablement check result indicating a successful check, the second check function.

Accordingly, acquiring the service disablement information by disabling the current interactive service by calling the service disablement function includes:

in response to the service enablement check result indicating a successful check, performing the step of acquiring the service disablement information by disabling the current interactive service by calling the service disablement function.

In some embodiments, for successful disablement of the current interactive service and successful enablement of the target interactive service during the service switching process, in response to the service switching instruction being triggered, the service disablement check is performed on the current interactive service and the service enablement check is performed on the target interactive service.

In some embodiments, the first check function is configured to perform the service disablement check.

In some embodiments, acquiring the service disablement check result by performing the service disablement check on the current interactive service by calling the first check function includes:

acquiring a first check result corresponding to the first check function by calling the first check function; and determining the first check result as the service disablement check result; or

transmitting a service disablement check instruction to the first service server by calling the first check function; and acquiring a first callback check result corresponding to the first check function, wherein the first callback check result is a service disablement check result corresponding to the current interactive service returned by the first service server.

In some embodiments, the first check function is configured to perform the service disablement check. In the case that the first service server pre-performs a registration configuration for the service disablement check, accordingly, in a scenario where the current interactive service is switched to the target interactive service, where the first check function is called, the first check function triggers an access operation to the first service server, transmits the service disablement check instruction to the first service server, and then instructs the first service server to perform the service disablement check on the current interactive service. Accordingly, the service disablement check instruction is to instruct the first service server to perform the service disablement check on the current interactive service. That is, the first service server performs the service disablement check on the current interactive service and generates the service disablement check result. Different interactive services correspond to different service disablement check conditions, which are pre-configured by a corresponding service side.

Accordingly, in the case that relevant service disablement check information (pre-configured service information required for checking whether the service is disabled or not) meets the service disablement check condition, the service disablement check result indicating a successful check is acquired; conversely, the service disablement check result indicating a failed check is acquired. The service disablement check result indicates whether the current interactive service can be disabled. The first service server returns the service disablement check result to the first check function in a form of a callback result (the first callback check result) corresponding to the first check function.

In some embodiments, some interactive services are often disabled directly. That is, there is no need to perform the registration configuration for the service disablement check. Accordingly, in the case that the first service server does not perform the registration configuration for the service disablement check, in a scenario where the current interactive service is switched to other interactive services, where the first check function is called, the first check result corresponding to the first check function is determined as the service disablement check result. The first check result indicates a successful check.

In the above embodiments, by calling the first check function, the operation of performing the disablement check on the current interactive service by the first service server is automatically triggered and the service disablement check result is acquired, or the first check result is directly determined as the service disablement check result, which greatly improves the flexibility of the service disablement check of the current interactive service during the process of service switching. Moreover, there is no need to access the first service server during the service disablement check process in the case that the first check result is served as the service disablement check result, such that the efficiency of service disablement check is improved, and thus the efficiency of service switching is improved.

In some embodiments, in response to the service disablement check result indicating a failed check, the target virtual space is disabled, and accordingly, an object in the target virtual space enters an original virtual space, which is a live-streaming room before the interactive service is enabled. In addition, corresponding service disablement information is fed back to the object in the target virtual space. The service disablement information indicates that the target virtual space is disabled in response to the failure to perform the service switching operation, such that subsequent actions of the user are not affected and the object in the target virtual space is allowed to acknowledge the reason for the disablement of the virtual space.

In some embodiments, acquiring the service enablement check result by performing the service enablement check on the target interactive service by calling the second check function includes:

acquiring a second check result corresponding to the second check function by calling the second check function; and determining the second check result as the service enablement check result; or

transmitting a service enablement check instruction to the second service server by calling the second check function; and acquiring a second callback check result corresponding to the second check function, wherein the second callback check result is a service enablement check result corresponding to the target interactive service returned by the second service server.

In some embodiments, the second check function is configured to perform the service enablement check. In the case that the second service server pre-performs a registration configuration for the service enablement check, accordingly, in a scenario where the current interactive service is switched to the target interactive service, where the second check function is called, the second check function triggers an access operation to the second service server, transmits the service enablement check instruction to the second service server, and then instructs the second service server to perform the service enablement check. Accordingly, the service enablement check instruction is to instruct the second service server to perform the service enablement check on the target interactive service. That is, the second service server performs the service enablement check on the target interactive service and generates the service enablement check result. Different interactive services correspond to different service enablement check conditions, which are pre-configured by a corresponding service side. Accordingly, in the case that relevant service enablement check information (pre-configured service information required for checking whether the service is enabled or not) meets the service enablement check condition, the service enablement check result indicating a successful check is acquired; conversely, the service enablement check result indicating a failed check is acquired. The service enablement check result indicates whether the target interactive service can be enabled in the target virtual space. The second service server returns the service enablement check result to the second check function in a form of a callback result (the second callback check result) corresponding to the second check function.

In some embodiments, some interactive services are often enabled directly. That is, there is no need to perform the registration configuration for the service enablement check. Accordingly, in the case that the second service server does not perform the registration configuration for the service enablement check, in a scenario where the current interactive service is switched to the target interactive service, where the second check function is called, the second check result corresponding to the second check function is determined as the service enablement check result. The second check result indicates a successful check.

In the above embodiments, by calling the second check function, the operation of performing the enablement check on the target interactive service by the second service server is automatically triggered and the service enablement check result is acquired, or the second check result corresponding to the second check function is directly determined as the service enablement check result, which greatly improves the flexibility of the service enablement check of the target interactive service during the process of service switching. Moreover, there is no need to access the second service server during the service enablement check process in the case that the second check result corresponding to the second check function is served as the service enablement check result, such that the efficiency of service enablement check is improved, and thus the efficiency of service switching is improved.

In some embodiments, in response to the service enablement check result indicating a failed check, the target virtual space is disabled, and accordingly, the object in the target virtual space enters the original virtual space. Furthermore, corresponding service disablement information is fed back to the object in the target virtual space. The service disablement information indicates that in response to the failure to perform the service switching operation, the target virtual space is disabled, such that the subsequent actions of the user are not affected and the object in the target virtual space is allowed to acknowledge the reason for the disablement of the virtual space.

In the above embodiments, prior to disabling the current interactive service, the disablement check is performed on the current interactive service and the enablement check is performed on the target interactive service respectively in combination with the first check function and the second check function, such that the current interactive service can be successfully disabled and the target interactive service can be successfully enabled in the subsequent period, and thus a success rate of the service switching is ensured.

In some embodiments, the method further includes:

setting the target virtual space to be in a locked state in response to the service switching instruction.

In some embodiments, in the target virtual space in the locked state, joining and exiting of the object is suspended, and the triggering of the service switching is suspended. The suspension of joining and exiting of the object refers to suspending the request of the object to join the target virtual space for the current interactive service, and suspending the request of the object to exit the current interactive service. The suspension of the triggering of the service switching refers to suspending the triggering of a new service switching instruction.

In the above embodiments, in response to the service switching instruction being triggered, by setting the target virtual space to be in the locked state, the problem of an error in the current service switching due to triggering the service switching again in the process of switching the interactive service from the current interactive service to the target interactive service is avoided. At the same time, a new object is prevented from being involved in the current interactive service and an object that has already been involved is prevented from exiting the current interactive service. In this way, the current service participant object successfully switches from being involved in the current interactive service to being involved in the target interactive service.

In S203, the service switching information is transmitted to the object in the target virtual space.

In some embodiments, the service switching information instructs the interactive service ongoing in the target virtual space to be switched from the current interactive service to the target interactive service and to switch a page content in a space page corresponding to the above object to a page content corresponding to the target interactive service. That is, by transmitting the service switching information to a terminal corresponding to the above object, the terminal is capable of, based on the service switching information, switching the page content in the space page of the target virtual space to the page content corresponding to the target interactive service, and providing notification information back to the object of the switching from the current interactive service to the target interactive service.

In some embodiments, in the case that the service switching instruction is triggered by a target object in the target virtual space, transmitting the service switching information to the object in the target virtual space includes:

transmitting the service switching information to the target object by calling a preset application interface; and

forwarding the service switching information to other objects based on a preset signaling service.

The preset application interface is a transmission interface corresponding to the target object when the target object initiates a service switching request. In some embodiments, the target object is any object in the target virtual space involved in the current interactive service, and the other objects are objects other than the target object among the objects in the target virtual space. The objects in the target virtual space include service participant objects involved in the current interactive service. Additionally, the objects in the target virtual space further include browsing objects.

In some embodiments, for the target object that actively initiates the service switching request, the service switching information is capable of being fast issued to the target object when being issued by the preset application interface, and thus the response speed of the service switching is greatly improved.

In some embodiments, because the target virtual space includes a large number of browsing objects in addition to the current service participant objects, directly issuing the service switching information by the server based on the application interface has high performance requirements for the server, and it is prone to problems such as issuance delay and downtime. Therefore, by forwarding through the preset signaling service, the stability of the server in the process of service switching is greatly improved.

In another optional embodiment, in the case that the service switching instruction is automatically triggered, the service switching information is directly forwarded by the preset signaling service to the objects in the target virtual space.

In the above embodiments, in the case that the service switching instruction is triggered by the target object, the service switching information is forwarded to the target object and other objects by calling the preset application interface and the preset signaling service respectively. In this way, on the basis of improving the response speed of the service switching, the throughput pressure of the server is reduced and the stability of the server is improved.

In some embodiments, upon transmitting the service switching information to the object in the target virtual space, the method further includes:

unlocking the target virtual space.

In some embodiments, the unlocking of the target virtual space is achieved by updating the locked state of the target virtual space to an unlocked state. Then, the joining and exiting of the service participant object resumes, and the triggering of the service switching resumes.

In the above embodiments, in the case that the service switching is completed, the joining and exiting of the service participant object and the triggering of the service switching resume by unlocking the target virtual space.

In some embodiments, the method further includes:
acquiring service state information corresponding to the current service participant object; and
based on the service state information, clearing objects in the target virtual space that do not satisfy the service switching condition.

Accordingly, transmitting the service switching information to the object in the target virtual space includes:

transmitting the service switching information to a target service participant object.

In some embodiments, the service state information characterizes a state of the current service participant object involved in the current interactive service in the target virtual space. The service state information includes a ready-to-switch state and an unprepared-to-switch state. The unprepared-to-switch state characterizes that the current service participant object has agreed to participate in the current interactive service but has not completed rendering the page content corresponding to the current interactive service, and the ready-to-switch state characterizes that the current service participant object has agreed to be involved in the current interactive service and has completed rendering the page content corresponding to the current interactive service.

In some embodiments, the service switching condition is preset service state information that enables one to switch from the current interactive service to the target interactive service. The service switching condition is the ready-to-switch state. Accordingly, clearing the objects in the target virtual space that do not satisfy the service switching condition includes clearing the current service participant objects whose service state information is the unprepared-to-switch state.

In some embodiments, the target service participant object is an object in the current service participant objects whose service state information satisfies the service switching condition. The object whose service state information satisfies the service switching condition is an object whose service state information is in the ready-to-switch state.

In some embodiments, corresponding notification information is issued to the object that does not satisfy the service switching condition, such that the corresponding object is allowed to acknowledge the reason for not successfully being involved in the current interactive service.

In the above embodiment, upon issuing the service switching information, by performing the object clearing in combination with the service state information corresponding to the current service participant object in the target virtual space, an object intending to join the current interactive service is effectively prevented from being illegally pulled into the target interactive service, and thus the rationality of the service switching is improved.

In some embodiments, upon acquiring the service switching information by switching the interactive service from the current interactive service to the target interactive service by calling the service switching function, the method further includes:

acquiring service type information corresponding to the target interactive service and service identification information of the target interactive service in the target virtual space; and

updating service indication information corresponding to the target virtual space based on the service type information and the service identification information.

In some embodiments, the service indication information indicates an interactive service currently running in the target virtual space. In addition, the service type information and the service identification information are served as the service indication information. In addition, the updating of the service indication information is performed in response to the target interactive service being successfully enabled. Accordingly, in the case that the service switching needs to be subsequently performed again, a current interactive service at the time of performing the service switching again is acknowledged in conjunction with the service indication information.

In the above embodiments, in the case that the current interactive service is switched to the target interactive service, the service indication information corresponding to the target virtual space is updated in combination with the service type information corresponding to the target interactive service and the service identification information of the target interactive service in the target virtual space, which facilitates acknowledgment of the interactive service currently running in the target virtual space.

In some embodiments, the method further includes: in response to the failure to perform the service switching operation, disabling the target virtual space and transmitting the service disablement information to the object in the target virtual space.

In some embodiments, in response to a failure in any part of the service switching operation, the service switching operation fails. Accordingly, the target virtual space is disabled and the object in the target virtual space enters the original virtual space. In addition, corresponding service disablement information is fed back to the object in the target virtual space. The service disablement information indicates that the target virtual space is disabled in response to the failure to perform the service switching operation.

In the above embodiment, in response to a failure to perform the service switching operation, by disabling the target virtual space and transmitting the service disablement information to the object, an effect on the subsequent actions of the object is effectively avoided, and at the same time, the object in the target virtual space is allowed to acknowledge the reason for the disablement of the virtual space, which greatly improves the user experience.

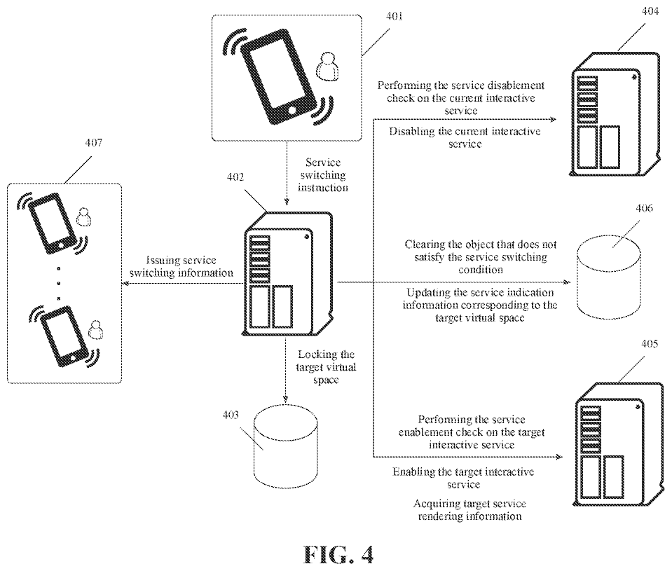

In some embodiments, the description is given using a scenario where a service switching is performed in combination with a first service server and a second service server. FIG. 4 is a schematic diagram of a service switching process according to some embodiments of the present disclosure. For example, as illustrated in FIG. 4, a terminal 401 corresponds to a target object (an object that triggers a service switching instruction), a server 402 is configured to perform the service switching, a database 403 is configured to record whether or not a target virtual space is in a locked state, a server 404 is the first service server, a server 405 is the second service server, a database 406 is configured to record information and service state information of a current service participant object in the target virtual space, and a terminal 407 corresponds to an object in the target virtual space. The object is a user who participates in the target virtual space via a terminal. The target virtual space may have a plurality of objects including a target object. The terminal 407 includes a plurality of objects and the terminal 401.

The object corresponding to the terminal 401 (i.e., a target object) triggers the service switching instruction, or the service switching instruction is automatically triggered. Then, the server 402 sets the target virtual space to be in the locked state in the database 403. Then, the server 402 accesses the service server 404 by calling a first check function to acquire a service disablement check result by performing a service disablement check on a current interactive service; in the case that the service disablement check result indicates a successful check, the server 402 accesses the service server 404 by calling a second check function to acquire a service enablement check result by performing a service enablement check on a target interactive service; and in the case that the service enablement check result indicates a successful check, based on objects that do not satisfy a service switching condition, the server 402 clears information of corresponding current service participant objects in the database 406. Then, the server 402 accesses the service server 404 by calling a service disablement function to acquire service disablement information by disabling the current interactive service. Then, the server 402 accesses the service server 405 by calling a service enablement function to acquire service enablement information by enabling the target interactive service in the target virtual space. Then, the server 402 updates service indication information corresponding to the target virtual space in the database 406 in combination with service type information corresponding to the target interactive service and service identification information of the target interactive service in the target virtual space. Then, the server 402 accesses the service server 405 by calling a service rendering function to acquire target service rendering information corresponding to the target interactive service, and generates service switching information based on the target service rendering information, the service disablement information, and the service enablement information, and then issues the service switching information to the terminal 407

In the process of service switching in the target virtual space, in response to the service switching instruction for the target virtual space being triggered, joining and exiting of a service participant object in the target virtual space and triggering of the service switching are suspended by setting the target virtual space to be in the locked state, such that the current service participant objects are capable of successfully switching from being involved in the current interactive service to being involved in the target interactive service. Moreover, the interactive service ongoing in the target virtual space is switched, by a service switching function, from the current interactive service to the target interactive service, and the acquired service switching information is transmitted to the objects in the target virtual space, which instructs the objects in the target virtual space to be switched from the current interactive service to the target interactive service and instructs a page content in a space page of the target virtual space to be switched to a page content corresponding to the target interactive service. In this way, the service switching in the target virtual space is completed by performing only one triggering of the service switching instruction without re-establishing a connection with the previous service participant objects, such that the operation path in the process of service switching is effectively shortened, and the convenience of the service switching operation is greatly improved, and thus the service switching efficiency and user experience are greatly improved.

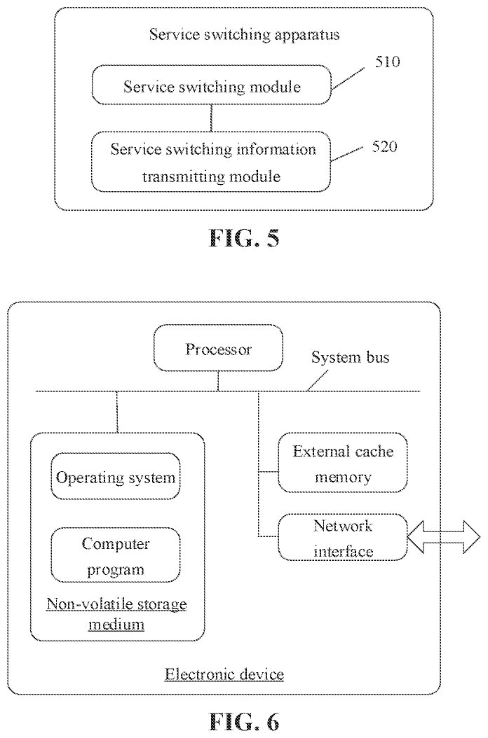

FIG. 5 is a block diagram of a service switching apparatus according to some embodiments of the present disclosure. Referring to FIG. 5, the apparatus includes:

a service switching module 510, configured to acquire service switching information by switching, in response to a service switching instruction for a target virtual space, an interactive service ongoing in the target virtual space from a current interactive service to a target interactive service indicated by the service switching instruction;

a service switching information transmitting module 510, configured to transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

In some embodiments, the service switching module 510 is configured to acquire the service switching information by switching the interactive service from the current interactive service to the target interactive service by calling a service switching function.

In some embodiments, the service switching function includes a service disablement function, a service enablement function, and a service rendering function. The service switching module 510 includes:

a service disabling unit, configured to acquire service disablement information by disabling the current interactive service by calling the service disablement function;

a service enabling unit, configured to acquire service enablement information corresponding to the target interactive service by enabling a target interactive service by calling the service enablement function;

a target service rendering information acquiring unit, configured to acquire target service rendering information corresponding to the target interactive service by calling a service rendering function; and

a service switching information generating unit, configured to generate service switching information based on the target service rendering information, the service disablement information, and the service enablement information.

In some embodiments, the service switching function further includes a first check function and a second check function, and the service switching module 510 further includes:

a service disablement check unit, configured to acquire a service disablement check result by performing a service disablement check on the current interactive service by calling the first check function;

a service enablement check unit, configured to acquire a service enablement check result by performing a service enablement check on the target interactive service by calling the second check function in response to the service disablement check result indicating a successful check; and

the service disabling unit, configured to perform, in response to the service enablement check result indicating a successful check, the step of acquiring the service disablement information by disabling the current interactive service in the target virtual space by calling the service disablement function.

In some embodiments, the service disablement check unit includes:

a first check result acquiring subunit, configured to acquire a first check result corresponding to the first check function by calling the first check function; and to determine the first check result as the service disablement check result; or

a service disablement check instruction transmitting subunit, configured to transmit a service disablement check instruction to a first service server corresponding to the current interactive service by calling the first check function, wherein the service disablement check instruction is to instruct the first service server to perform the service disablement check on the current interactive service in the target virtual space; and

a first callback check result acquiring subunit, configured to acquire a first callback check result corresponding to the first check function, wherein the first callback check result is a service disablement check result corresponding to the current interactive service returned by the first service server.

In some embodiments, the service enablement check unit includes:

a second check result acquiring subunit, configured to acquire a second check result corresponding to the second check function by calling a second check function; and to determine the second check result as the service enablement check result; or

a service enablement check instruction transmitting subunit, configured to transmit a service enablement check instruction to a second service server corresponding to the target interactive service by calling the second check function, wherein the service enablement check instruction is to instruct the second service server to perform the service enablement check on the target interactive service; and

a second callback check result acquiring subunit, configured to acquire a second callback check result corresponding to the second check function, wherein the second callback check result is a service enablement check result corresponding to the target interactive service returned by the second service server.

In some embodiments, the service disabling unit includes:

a service disabling subunit, configured to generate the service disablement information by locally disabling the current interactive service by calling the service disablement function; or

a service disablement instruction transmitting subunit, configured to transmit a service disablement instruction to the first service server corresponding to the current interactive service by calling the service disablement function, wherein the service disablement instruction is to instruct the first service server to disable the current interactive service; and

a first callback result acquiring subunit, configured to acquire a first callback result corresponding to the service disablement function, wherein the first callback result is service disablement information generated by the first service server in response to disabling the current interactive service.

In some embodiments, the service enablement unit includes:

a service enablement subunit, configured to generate the service enablement information by locally enabling the target interactive service by calling the service enablement function; or

a service enablement instruction transmitting subunit, configured to transmit a service enablement instruction to the second service server corresponding to the target interactive service by calling the service enablement function, wherein the service enablement instruction is to instruct the second service server to enable the target interactive service in the target virtual space; and

a second callback result acquiring subunit, configured to acquire a second callback result corresponding to the service enablement function, wherein the second callback result is service enablement information generated by the second service server in response to enabling the target interactive service in the target virtual space.

In some embodiments, the target service rendering information acquiring unit includes:

a service rendering information acquiring subunit, configured to acquire service rendering information corresponding to the service rendering function by calling the service rendering function; and to determine the service rendering information as the target service rendering information; or

a service information configuration instruction transmitting subunit, configured to transmit a service information configuration instruction to the second service server corresponding to the target interactive service by calling the service rendering function, wherein the service information configuration instruction is to instruct the second service server to configure the target service rendering information corresponding to the target interactive service; and

a third callback result acquiring subunit, configured to acquire a third callback result corresponding to the service enablement function, wherein the third callback result is the target service rendering information returned by the second service server.

In some embodiments, the apparatus further includes:

a virtual space locking module, configured to set the target virtual space to be in a locked state in response to the service switching instruction, wherein in the target virtual space in the locked state, joining and exiting of an object and triggering of the service switching are suspended.

In some embodiments, the apparatus further includes:

a virtual space unlocking module, configured to unlock the target virtual space.

In some embodiments, the apparatus further includes:

a virtual space disabling module, configured to disable the target virtual space in response to a failure to perform the service switching operation; and

a service disablement information transmitting module, configured to transmit the service disablement information to an object, wherein the service disablement information indicates that the target virtual space is disabled in response to the failure to perform the service switching operation, and the target virtual space is a live-streaming room for performing the current interactive service.

In some embodiments, the service switching instruction is triggered by a target object in the objects, and the service switching information transmitting module 520 includes:

a service switching information transmitting unit, configured to transmit the service switching information to the target object by calling a preset application interface; and

a service switching information forwarding unit, configured to forward the service switching information to other objects based on a preset signaling service;

wherein the other objects are objects other than the target object in the objects.

In some embodiments, the apparatus further includes:

a service state information acquiring module, configured to acquire service state information corresponding to a current service participant object in the objects, wherein the service state information characterizes a state of the current service participant object involved in the current interactive service in the target virtual space;

an object clearing module, configured to clear, based on the service state information, an object in the target virtual space that does not satisfy a service switching condition; and

a service switching information transmitting module 520, configured to transmit the service switching information to a target service participant object, wherein the target service participant object is an object in the current service participant object whose service state information satisfies the service switching condition.

In some embodiments, the apparatus further includes:

an information acquiring module, configured to acquire service type information corresponding to the target interactive service and service identification information of the target interactive service in the target virtual space; and

a service state information updating module, configured to update, based on the service type information and the service identification information, service indication information corresponding to the target virtual space, wherein the service indication information indicates an interactive service currently running in the target virtual space.

Concerning the apparatus in the above embodiments, the specific manner in which each module operates has been described in detail in the embodiments relating to the method, which is not limited herein.

FIG. 6 is a block diagram of an electronic device for service switching according to some embodiments of the present disclosure. The electronic device is a server, and an internal structure diagram thereof is illustrated in FIG. 6. The electronic device includes a processor, a memory, and a network interface that are connected via a system bus. The processor of the electronic device is configured to provide computing and control capabilities. The memory of the electronic device includes a non-transitory storage medium and an internal memory. The non-volatile storage medium stores an operating system and one or more computer programs. The internal memory provides an environment for the operation of the operating system and the one or more computer programs in the non-transitory storage medium. The network interface of the electronic device is configured to communicate with an external terminal via a network connection. The one or more computer programs, when loaded and run by the processor of the electronic device, cause the electronic device to perform a service switching method.

It should be understood by those skilled in the art that the structure illustrated in FIG. 6, which is only a block diagram of a portion of structures related to the technical solutions of the present disclosure, does not constitute any limitation on the electronic device to which the technical solutions of the present disclosure are applicable, and the specific electronic device includes more or fewer components than illustrated in the figures, or a combination of some of the components, or has a different arrangement of components.

In some exemplary embodiments, an electronic device is further provided. The electronic device includes a processor, a memory configured to store one or more instructions executable by the processor. The processor, when loading and executing the one or more instructions, is caused to:

acquire service switching information by switching, in response to a service switching instruction for a target virtual space, an interactive service ongoing in the target virtual space from a current interactive service to a target interactive service indicated by the service switching instruction; and

transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

In some embodiments, the processor, when loading and executing the one or more instructions, is further caused to:

acquire the service switching information by switching the interactive service from the current interactive service to the target interactive service by calling a service switching function.

In some embodiments, the service switching function includes a service disablement function, a service enablement function, and a service rendering function; and the processor, when loading and executing the one or more instructions, is further caused to:

acquire service disablement information by disabling the current interactive service by calling the service disablement function;

acquire service enablement information corresponding to the target interactive service by enabling the target interactive service by calling the service enablement function;

acquire target service rendering information corresponding to the target interactive service by calling the service rendering function; and

generate the service switching information based on the target service rendering information, the service disablement information, and the service enablement information.

In some embodiments, the service switching function further includes a first check function and a second check function; and the processor, when loading and executing the one or more instructions, is further caused to:

acquire a service disablement check result by performing a service disablement check on the current interactive service by calling the first check function; and

acquire a service enablement check result by performing a service enablement check on the target interactive service by calling, in response to the service disablement check result indicating a successful check, the second check function.

In some embodiments, the processor, when loading and executing the one or more instructions, is further caused to:

in response to the service enablement check result indicating a successful check, perform the step of acquiring the service disablement information by disabling the current interactive service by calling the service disablement function.

In some embodiments, the processor, when loading and executing the one or more instructions, is further caused to:

acquire a first check result corresponding to the first check function by calling the first check function; and determine the first check result as the service disablement check result; or

transmit a service disablement check instruction to a first service server corresponding to the current interactive service by calling the first check function, wherein the service disablement check instruction is to instruct the first service server to perform the service disablement check on the current interactive service; and acquire a first callback check result corresponding to the first check function, wherein the first callback check result is the service disablement check result corresponding to the current interactive service, which is returned by the first service server.

In some embodiments, the processor, when loading and executing the one or more instructions, is further caused to:

acquire a second check result corresponding to the second check function by calling the second check function; and determine the second check result as the service enablement check result; or

transmit a service enablement check instruction to a second service server corresponding to the target interactive service by calling the second check function, wherein the service enablement check instruction is to instruct the second service server to perform the service enablement check on the target interactive service; and acquire a second callback check result corresponding to the second check function, wherein the second callback check result is the service enablement check result corresponding to the target interactive service, which is returned by the second service server.

In some embodiments, the processor, when loading and executing the one or more instructions, is further caused to:

generate the service disablement information by locally disabling the current interactive service by calling the service disablement function; or

transmit a service disablement instruction to a first service server corresponding to the current interactive service by calling the service disablement function, wherein the service disablement instruction is to instruct the first service server to disable the current interactive service; and acquire a first callback result corresponding to the service disablement function, wherein the first callback result is the service disablement information generated by the first service server in response to disabling the current interactive service.

In some embodiments, the processor, when loading and executing the one or more instructions, is further caused to:

generate the service enablement information by locally enabling on the target interactive service by calling the service enablement function; or

transmit a service enablement instruction to a second server corresponding to the target interactive service by calling the service enablement function, wherein the service enablement instruction is to instruct the second server to enable the target interactive service in the target virtual space; and acquire a second callback result corresponding to the service enablement function, wherein the second callback result is the service enablement information generated by the second server in response to enabling the target interactive service in the target virtual space.

In some embodiments, the processor, when loading and executing the one or more instructions, is further caused to:

acquire service rendering information corresponding to the service rendering function by calling the service rendering function; and determining the service rendering information as the target service rendering information; or

transmit a service information configuration instruction to a second service server corresponding to the target interactive service by calling the service rendering function, wherein the service information configuration instruction is to instruct the second service server to configure the target service rendering information; and acquire a third callback result corresponding to the service enablement function, wherein the third callback result is the target service rendering information returned by the second service server.

In some embodiments, the processor, when loading and executing the one or more instructions, is further caused to:

set the target virtual space to be in a locked state in response to the service switching instruction, wherein in the target virtual space in the locked state, joining and exiting of an object are suspended, and triggering of the service switching is suspended.

In some embodiments, the processor, when loading and executing the one or more instructions, is further caused to:

unlock the target virtual space.

In some embodiments, the processor, when loading and executing the one or more instructions, is further caused to:

in response to a failure to perform a service switching operation, disable the target virtual space and transmitting service disablement information to the object; wherein the service disablement information indicates that the target virtual space is disabled in response to the failure to perform the service switching operation, and the target virtual space is a live-streaming room for performing the current interactive service.

In some embodiments, the service switching instruction is triggered by a target object in the objects. The processor, when loading and executing the one or more instructions, is further caused to:

transmit the service switching information to the target object by calling a preset application interface; and

forward the service switching information to other objects according to a preset signaling service;

wherein the other objects are objects other than the target object in the objects.

In some embodiments, the processor, when loading and executing the one or more instructions, is further caused to:

acquire service state information corresponding to a current service participant object in the objects, wherein the service state information characterizes a state of the current service participant object involved in the current interactive service in the target virtual space; and

clear, based on the service state information, objects in the target virtual space that do not satisfy a service switching condition.

The processor, when loading and executing the one or more instructions, is further caused to:

transmit the service switching information to a target service participant object, wherein the target service participant object is an object in the current service participant object, whose service state information satisfies the service switching condition.

In some embodiments, the processor, when loading and executing the one or more instructions, is further caused to:

acquire service type information corresponding to the target interactive service and service identification information of the target interactive service in the target virtual space; and

update, based on the service type information and the service identification information, service indication information corresponding to the target virtual space, wherein the service indication information indicates an interactive service currently running in the target virtual space.

In some embodiments, a computer-readable storage medium storing one or more instructions therein is provided. The one or more instructions, when loaded and executed by a processor of an electronic device, cause the electronic device to:

acquire service switching information by switching, in response to a service switching instruction for a target virtual space, an interactive service ongoing in the target virtual space from a current interactive service to a target interactive service indicated by the service switching instruction; and

transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

In some embodiments, a computer program product storing one or more instructions is provided. The computer program, when loaded and run on a computer, causes the computer to:

acquire service switching information by switching, in response to a service switching instruction for a target virtual space, an interactive service ongoing in the target virtual space from a current interactive service to a target interactive service indicated by the service switching instruction; and

transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

Those skilled in the art may understand that all or part of the processes implementing the methods of the embodiments described above can be accomplished by instructing the relevant hardware by a computer program, which may be stored in a non-transitory computer-readable storage medium. The computer program, when loaded and run on a computer, may include processes of the embodiments of the various methods described above. Any reference to a memory, storage, database, or other medium used in the embodiments according to the present disclosure may include a non-volatile and/or a volatile memory. The non-transitory memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration instead of limitation, the RAM is available in a variety of forms, such as a static RAM (SRAM), a dynamic RAM (DRAM), a synchronous DRAM (SDRAM), a dual data rate SDRAM (DDRSDRAM), an enhanced SDRAM (ESDRAM), a synchronous-link DRAM (SLDRAM), a Rambus direct RAM (RDRAM), a direct Rambus dynamic RAM (DRDRAM), and a Rambus dynamic RAM (RDRAM).

Other embodiments of the present disclosure will readily come to mind to those skilled in the art upon consideration of the specification and practice of the invention disclosed herein. The present disclosure is intended to cover any variations, uses, or adaptations of the present disclosure that follow the general principles of the present disclosure and include common knowledge or conventional technical means in the art not disclosed herein. The specification and embodiments are to be regarded as exemplary only, and the scope and spirit of the present disclosure is indicated by the following claims.

It should be noted that the present disclosure is not limited to the precise structure that has been described above and illustrated in the accompanying drawings, and is subject to various modifications and changes without departing from its scope. The scope of the present disclosure is limited only by the claims.

What is claimed is:

1. A service switching method, applicable to an electronic device configured to perform a service switching service, comprising:
acquiring service switching information by switching, in response to a service switching instruction for a target virtual space, an interactive service ongoing in the target virtual space from a current interactive service to a target interactive service indicated by the service switching instruction, wherein a plurality of objects participate in the interactive service, and the service switching instruction is triggered by a target object who is one of the plurality of objects in the target virtual space or is automatically triggered; and
transmitting the service switching information to the plurality of objects in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

2. The service switching method according to claim 1, wherein acquiring the service switching information by switching the interactive service ongoing in the target virtual space from the current interactive service to the target interactive service indicated by the service switching instruction comprises:
acquiring the service switching information by switching the interactive service from the current interactive service to the target interactive service by calling a service switching function.

3. The service switching method according to claim 1, wherein
the service switching function comprises: a service disablement function, a service enablement function, and a service rendering function; and
acquiring the service switching information by switching the interactive service from the current interactive service to the target interactive service by calling the service switching function comprises:
acquiring service disablement information by disabling current interactive service by calling the service disablement function;
acquiring service enablement information corresponding to the target interactive service by enabling the target interactive service by calling the service enablement function;
acquiring target service rendering information corresponding to the target interactive service by calling the service rendering function; and
generating the service switching information based on the target service rendering information, the service disablement information, and the service enablement information.

4. The service switching method according to claim 3, wherein
the service switching function further comprises: a first check function and a second check function; and
the method further comprises:
acquiring a service disablement check result by performing a service disablement check on the current interactive service by calling the first check function; and
acquiring a service enablement check result by performing a service enablement check on the target interactive service by calling, in response to the service disablement check result indicating a successful check, the second check function; and
acquiring the service disablement information by disabling the current interactive service by calling the service disablement function comprises:
in response to the service enablement check result indicating a successful check, performing the step of acquiring the service disablement information by disabling the current interactive service by calling the service disablement function.

5. The service switching method according to claim 4, wherein acquiring the service disablement check result by performing the service disablement check on the current interactive service by calling the first check function comprises:
acquiring a first check result corresponding to the first check function by calling the first check function; and determining the first check result as the service disablement check result; or
transmitting a service disablement check instruction to a first service server corresponding to the current interactive service by calling the first check function, wherein the service disablement check instruction is to instruct the first service server to perform the service disablement check on the current interactive service; and acquiring a first callback check result corresponding to the first check function, wherein the first callback check result is the service disablement check result corresponding to the current interactive service, which is returned by the first service server.

6. The service switching method according to claim 4, wherein acquiring the service enablement check result by performing the service enablement check on the target interactive service by calling the second check function comprises:
acquiring a second check result corresponding to the second check function by calling the second check function; and determining the second check result as the service enablement check result; or
transmitting a service enablement check instruction to a second service server corresponding to the target interactive service by calling the second check function, wherein the service enablement check instruction is to instruct the second service server to perform the service enablement check on the target interactive service; and acquiring a second callback check result corresponding to the second check function, wherein the second callback check result is the service enablement check result corresponding to the target interactive service, which is returned by the second service server.

7. The service switching method according to claim 3, wherein acquiring the service disablement information by disabling the current interactive service by calling the service disablement function comprises:
generating the service disablement information by locally disabling the current interactive service by calling the service disablement function; or
transmitting a service disablement instruction to a first service server corresponding to the current interactive service by calling the service disablement function, wherein the service disablement instruction is to instruct the first service server to disable the current interactive service; and acquiring a first callback result corresponding to the service disablement function, wherein the first callback result is the service disablement information generated by the first service server in response to disabling the current interactive service.

8. The service switching method according to claim 3, wherein acquiring the service enablement information corresponding to the target interactive service by enabling the target interactive service by calling the service enablement function comprises:
generating the service enablement information by locally enabling the target interactive service by calling the service enablement function; or
transmitting a service enablement instruction to a second server corresponding to the target interactive service by calling the service enablement function, wherein the service enablement instruction is to instruct the second server to enable the target interactive service in the target virtual space; and acquiring a second callback result corresponding to the service enablement function, wherein the second callback result is the service enablement information generated by the second server in response to enabling the target interactive service in the target virtual space.

9. The service switching method according to claim 3, wherein acquiring the target service rendering information corresponding to the target interactive service by calling the service rendering function comprises:
acquiring service rendering information corresponding to the service rendering function by calling the service rendering function; and determining the service rendering information as the target service rendering information; or
transmitting a service information configuration instruction to a second service server corresponding to the target interactive service by calling the service rendering function, wherein the service information configuration instruction is to instruct the second service server to configure the target service rendering information; and acquiring a third callback result corresponding to the service enablement function, wherein the third callback result is the target service rendering information returned by the second service server.

10. The service switching method according to claim 1, further comprising:
setting the target virtual space to be in a locked state in response to the service switching instruction, wherein in the target virtual space in the locked state, joining and exiting of an object are suspended, and triggering of the service switching is suspended.

11. The service switching method according to claim 10, further comprising: unlocking the target virtual space.

12. The service switching method according to claim 1, further comprising:
in response to a failure to perform a service switching operation, disabling the target virtual space and transmitting service disablement information to the plurality of objects; wherein the service disablement information indicates that the target virtual space is disabled in response to the failure to perform the service switching operation, and the target virtual space is a live-streaming room for performing the current interactive service.

13. The service switching method according to claim 1, wherein
the service switching instruction is triggered by the target object in the objects; and
transmitting the service switching information to the plurality of objects in the target virtual space comprises:
transmitting the service switching information to the target object by calling a preset application interface; and
forwarding the service switching information to other objects according to a preset signaling service;
wherein the other objects are objects other than the target object in the objects.

14. The service switching method according to claim 1, further comprising:
acquiring service state information corresponding to the plurality of the objects, wherein the service state information characterizes a state of the plurality of objects in the current interactive service in the target virtual space; and
clearing, based on the service state information, objects in the target virtual space that do not satisfy a service switching condition; and
transmitting the service switching information to the plurality of objects in the target virtual space comprises:
transmitting the service switching information to objects in the target virtual space that satisfy the service switching condition.

15. The service switching method according to claim 1, further comprising:
acquiring service type information corresponding to the target interactive service and service identification information of the target interactive service in the target virtual space; and
updating, based on the service type information and the service identification information, service indication information corresponding to the target virtual space, wherein the service indication information indicates an interactive service currently running in the target virtual space.

16. A service switching method, applicable to an electronic device configured to perform a service switching service, comprising:
acquiring service switching information by calling a service switching function, in response to a service switching instruction for a target virtual space, performing service switching operations to switch an interactive service ongoing in the target virtual space from a current interactive service to a target interactive service indicated by the service switching instruction, wherein a plurality of objects participate in the interactive service, and the service switching instruction is triggered by a target object who is one of the plurality of objects in the target virtual space or automatically triggered, wherein the service switching function comprises a service disablement function, a service enablement function, and a service rendering function, and wherein the current interactive service is provided by a first service server, and the target interactive service is provided by a second service server; and
transmitting the service switching information to the plurality of objects in the target virtual space, wherein the service switching information is to instruct the interactive service ongoing in the target virtual space to be switched from the current interactive service to the target interactive service and to switch a page content in a space page of the target virtual space to a page content corresponding to the target interactive service such that a plurality of terminals corresponding to the plurality of objects are capable of switching the page content in the space page of the target virtual space to the page content corresponding to the target interactive service.

17. The service switching method according to claim 16, wherein acquiring the service switching information by switching the interactive service from the current interactive service to the target interactive service by calling the service switching function comprises:
accessing the first service server, performing a service disablement check on the current interactive service, and acquiring service disablement information by disabling current interactive service by calling the service disablement function;
accessing the second service server, performing a service enablement check on the target interactive service, and acquiring service enablement information corresponding to the target interactive service by enabling the target interactive service by calling the service enablement function;
accessing the second service server, performing a service rendering check, and acquiring target service rendering information corresponding to the target interactive service by calling the service rendering function; and
generating the service switching information based on the target service rendering information, the service disablement information, and the service enablement information.

18. An electronic device configured to perform a service switching service, comprising:
a processor; and
a memory, configured to store one or more instructions executable by the processor;
wherein the processor, when loading and executing the one or more instructions, is caused
acquire service switching information by switching, in response to a service switching instruction for a target virtual space, an interactive service ongoing in the target virtual space from a current interactive service to a target interactive service indicated by the service switching instruction; and
transmit the service switching information to an object in the target virtual space, wherein the service switching information is to instruct the interactive service ongoing in the target virtual space to be switched from the current interactive service to the target interactive service and to switch a page content in a space page of the target virtual space to a page content corresponding to the target interactive service.

19. A non-transitory computer-readable storage medium storing one or more instructions therein, wherein the one or more instructions, when loaded and executed by a processor of an electronic device configured to perform a service switching service, cause the electronic device to perform the method according to claim 1.
